(19) United States
(12) Patent Application Publication
(10) Pub. No.: US 2009/0266108 A1
(43) Pub. Date: Oct. 29, 2009

(54) ASH FILLED GEM STONES FOR MEMENTOS OF LOVED ONES

(75) Inventors: Craig M. Balme, Coventry, RI (US); Stephen D. Balme, Coventry, RI (US)

Correspondence Address: Craig M. Balme, 118 Colvintown Rd., Coventry, RI, 02816, US

(73) Assignee: PET GEMS, LLC, COVENTRY, RI (US)

(21) Appl. No.: 12/111,200

(22) Filed: Apr. 29, 2008

(51) Int. Cl. A44C 15/00; B23P 17/00

(52) U.S. Cl. 63/1.11; 27/1; 29/530

(57) ABSTRACT

A lasting memento derived from the ashes of a cremated human or pet, and a method of manufacture thereof. A rough gem stone of either natural or man made chemistry can have a hole or plurality of holes that are drilled into them. The ashes are subsequently inserted into the drilled hole, whereupon, the holes are permanently sealed with known materials and sealing techniques. The rough stones are then faceted using conventional faceting and polishing procedures. The same techniques may be used to ‘drill and fill’ completed, faceted gem stones and man made synthetic crystals, resulting in the same permanent memento that may be incorporated into an article of jewelry.

### BACKGROUND

This invention relates to the filling of drilled holes in gem stones and manmade synthetic crystals, with ashes from a cremated pet or human, for the purpose of creating a lasting memento. The term gemstone is used herein pursuant to the Federal Trade Commission's, “Guides for the Jewelry, Precious Metals, and Pewter Industries”, paragraph 23.25.

### DESCRIPTION OF PRIOR ART

Mementos derived from the ashes of cremated pets and humans have been manufactured, assembled, and produced for numerous eons. It is understandable the position mementos hold in our lives as our loved ones pass on. Many types and styles of mementos have been designed, including wall plaques, urns, lockets, ash filled glass items, as well as the new generation of synthetic gems, manufactured from the residual carbon from interrupted cremations. A method of manufacturing a synthetic memorial from ashes is disclosed in U.S. Patent Application No. 20040031434 to VandenBiesen et al.

Even though there exist several methods of manufacturing synthetic gems from the residual carbons in human or pet ashes, the finished results are of a chemistry and nature that preclude the application of the huge selection of natural, and other man made, synthetic gemstone materials, which are available for creating such mementos.

The need for utilization of most natural occurring gem stones as well as man made synthetic crystals to be applied to the creation of lasting gemstone mementos is wide spread and fills a broader range of appeals and price ranges than does the synthetic gem stones created from only the collected carbon from ashes.

Further, mementos for deceased humans or pets in which residual ashes are mixed with particulate glass is a means of creating a lasting memento. An example of this method is disclosed in U.S. Pat. No. 7,266,866 to Vogel et al. Although these ash infused glass mementos may be colored and further faceted, they are not the more desirable naturally occurring or synthetic gem stones used in jewelry.

The broad availability of natural gem stones and synthetic crystals that may have inserted in them, allows for the creation of an item that may be used in the assembly of unique articles of jewelry, by those crafted in the art.

It is therefore an object of the present invention to provide a novel memento comprised of a wide variety of naturally occurring gem stones as well as man made synthetic crystals that have permanently placed into them a portion of the ashes from a cremated pet or human.

A further reference, with regard to creating mementos, are those devices that are created from numerous parts to form an article of jewelry configured as a container. The article of jewelry may be a pendant, and is an assembly that has a chamber that may be filled with various articles or mementos. An example of such an assembly is U.S. Patent Application No. 20040045316 to Naor. The article of jewelry in Naor differs from this invention in that said article is an assembly of parts. Screw threads, set-screws and threaded sealing plugs, that provide a closure for said chamber certainly create the pendant mementos, but are not gems stones having all the embodiments of this invention.

Thus, there is a need for mementos that can be created by placing ashes into drilled holes in gemstones, as well as a method of manufacture thereof.

### SUMMARY

In one embodiment, the invention is a method for producing a memento from a naturally occurring gem stone. Said gemstone has created in it, holes that may be filled with ashes from a cremated human or pet. The holes are permanently sealed with non allergic materials. Subsequently, the stones are finished by faceting and polishing. Finally, the completed stones may be added to items of jewelry.

In a further embodiment, the invention is a method for producing a memento from a man made synthetic crystal. Said crystals are made for the jewelry industry. They are ‘grown’ from ‘seeds’ in molten gemstock materials. The resulting crystal is cut into segments. A segment has created in it, holes that may be filled with ashes from a cremated human or pet. The holes are permanently sealed with non allergic materials. Subsequently, the stones are finished by faceting and polishing. Finally, the completed stones may be added to items of jewelry

In yet a further embodiment, the invention is a method for producing a memento from a previously faceted gem stone. Said gemstone has created in them, holes that may be filled with ashes from a cremated human or pet. The holes are permanently sealed with non allergic materials. Also, said holes allow for the addition of various other color enhancing materials to be placed into the stone's orifice along with the ashes from a pet or human. Further still provide a cost affective method of providing a lasting memento of gem stone quality to the loved ones of cremated pets and humans. Finally, the completed stones may be added to items of jewelry

These, together with other objects of the invention, along with the various features of novelty which characterize the invention, are pointed out with particularity in the detailed description annexed to and forming a part of this disclosure. For a better understanding of the invention, its operating advantages and the specific objects attained by its uses, reference should be had to the accompanying descriptive matter in which there is illustrated a preferred embodiment of the invention.

### BRIEF DESCRIPTIONS OF THE DRAWINGS

The exact nature of this invention as well as its objects and advantages will be readily understood upon consideration of the following specification as related to the attendant drawings wherein like reference numerals throughout the drawings indicate like parts, and wherein:

FIG. 1 shows rough gem stone with hole being drilled.

FIG. 2 shows rough gem stone with its hole being filled with ashes.

FIG. 3 shows sealing material being prepared for mixing.

FIG. 4 shows mixing of sealing material.

FIG. 5 shows applying sealing material.

FIG. 6 shows the filled and sealed gem stone mounted on faceting dop and being rough cut on faceting machine lap.

FIG. 7 shows the filled and sealed gem stone being polished on faceting machine lap.

FIG. 8 illustrates finished filled and sealed gem stone that has been faceted and polished.

FIG. 9 Shows a finished faceted undrilled gem stone.

FIG. 10 shows the tip of the pavilion being ground flat to allow for drilling.

FIG. 11 shows the finished faceted stone with drilled hole.

FIG. 12 shows the finished faceted stone in drilling fixture, being drilled.

FIG. 13 shows the finished faceted stone having its drilled hole being polished.

FIG. 14 shows the finished faceted stone being filled with ashes.

FIG. 15 illustrates the finished faceted and filled stone being sealed with sealing material.

### DETAILED DESCRIPTION

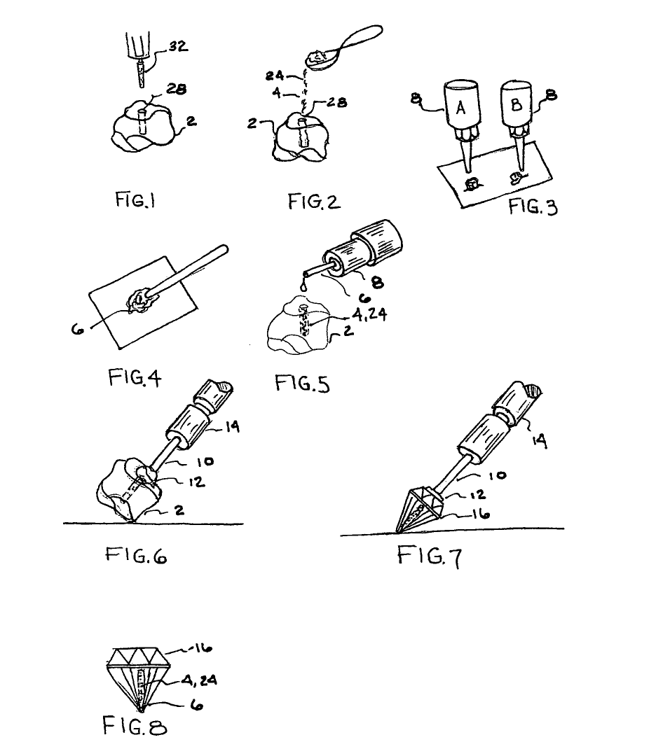

An embodiment of the present invention is illustrated in FIGS. 1-8. The rough gem stone 2 or synthetic crystal has been selected for size and color to allow for the improved position for drilling and the subsequent optimum faceting geometry. A flat 28 has been ground on the end opposite the selected drilling entry point. The illustration shows the drill 32 and drilled hole 28, as being deep enough to allow for small amounts of ashes and yet allow for correct faceting of the pavilion and crown, thus allowing for the creation of optimum gem qualities, including brilliance and shape.

When drilled hole 28 has been completed, it may be polished using a small mandrel and polishing paste, or it may be filled immediately with ashes 4. In certain instances it may be chosen to enhance the coloration within the gem stone by the addition of color enhancing materials 24.

A suitable non-allergenic sealing material 6 is prepared in the correct ratios and mixed to the correct consistency. The sealing material is placed into a dispenser 8 that has its orifice size consistent with the drilled hole 28 in the unfinished, rough gem stone 2. The remaining unfilled opening has applied the sealing material 6 and allowed to dry according to manufacturer's instructions.

The drilled, filled and sealed unfinished, rough gem stone is fastened to a jeweler's faceting dop 10 using an appropriate doping adhesive 12. Said doping adhesive may be a doping wax, two part epoxy, or cyanoacrylate that is generally used in the jewelry industry to adhere unfaceted stones to jewelry dops. The faceting dop 10 is mounted into the faceting machine spindle 14 in anticipation of final faceting. The rough gem stone 2 is then rough faceted to a geometry consistent with the client's wishes.

Finally, the gem stone is polished on the faceting machine, removed from the dop and cleaned. It is then hand polished and prepared for shipping.

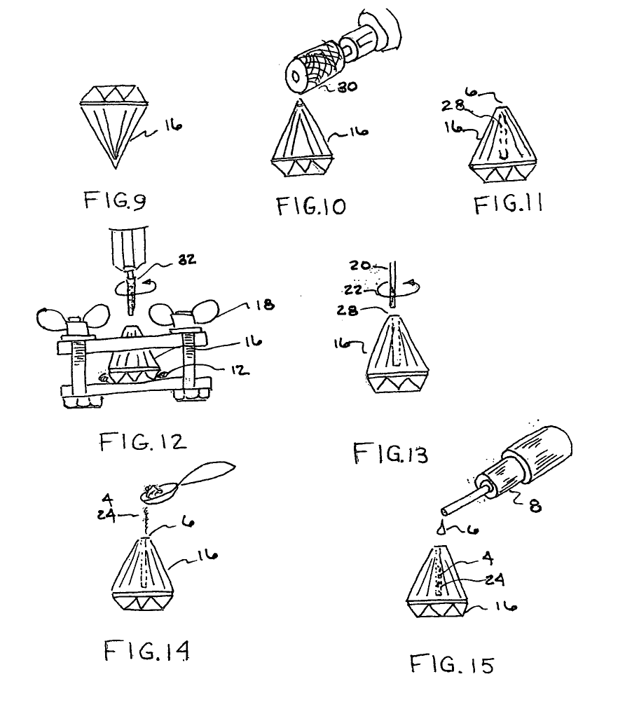

An additional embodiment is illustrated in FIGS. 9-15. In this embodiment, the gem stone starts with a finished faceted gem stone or synthetic crystal 16. The gem stone has a small flat 26 ground at the end of the pavilion, parallel to the axis of the desired drilled hole 28, using a small grinding wheel 30 of silicon carbide or diamond surface. The small flat surface allows for ease in starting the drilling procedure. The actual drilling of the hole may be accomplished utilizing mechanical drilling techniques using diamond burrs, ultra sonic drilling with enhancing cutting additives or by laser drilling.

The finished faceted gem stone 16 is mounted in a suitable drilling fixture 18, which is designed to hold the gem stone firmly in place during mechanical drilling. Further, a doping adhesive 12 can be employed to additionally secure the gem stone. The illustrated drilling fixture is merely a sample, as many designs may be applied to best fit the gem stone size and drilling style. An example of this is, a stone being drilled using an ultra sonic drill, which may have the stone fastened to the table surface of a vertically adjustable fixture to allow for better access to the drilling member.

The completed hole may be further polished using a soft metal or hardwood polishing mandrel 20 and a polishing medium 22 such as fine particulate diamond paste.

The drilled finished faceted stone 16 then has the ash inserted into the newly prepared drilled hole 28.

On completion of the correct filling, the selected sealing material 6 is prepared and added to the sealant dispenser 8. The sealing material is then applied to the terminus end of the orifice thus permanently sealing the ashes, within the gem stone.

The finished faceted, drilled, filled and sealed gem stone is then cleaned, hand polished further, and prepared for shipping.

Although the description above contains many specificities, these should not be construed as limiting the scope of the invention but as merely providing illustrations of some of the presently preferred embodiments of this invention. For example the drilled hole in the gem stone can have added to it other personal materials including, hair, DNA or various other organics.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

1. A gemstone comprising:
an orifice to store organic material,
organic material inserted into the orifice, and
a sealing material to seal a terminus end of the orifice.

2. The gemstone of claim 1, wherein the gemstone is naturally occurring.

3. The gemstone of claim 1, wherein the gemstone is a synthetically created crystal.

4. The gemstone of claim 1, wherein the orifice is man-made and created by drilling a orifice in the gemstone.

5. The gemstone of claim 1, wherein the organic material stored in the gemstone is the residual carbons of human ashes.

6. The gemstone of claim 1, wherein the organic material stored in the gemstone is the residual carbons of animal ashes.

7. The gemstone of claim 1, wherein the organic material stored in the gemstone consists of at least one of hair, DNA, or other organic material.

8. A method of creating a memento comprising:
selecting an unfinished gemstone,
selecting a drilling side on the unfinished gemstone,
flattening an opposite side parallel to the drilling side of the unfinished gemstone with a grounding tool,
drilling a orifice on the opposite side of the unfinished gemstone,
inserting organic material into the orifice,
sealing the orifice by affixing a sealing material to a terminus end of the orifice,
fastening the unfinished gemstone to a faceting dop using a doping adhesive,
faceting the unfinished gemstone to a desired geometry to a finished gemstone, and
polishing the finished gemstone.

9. The method of claim 8, further comprising drilling the orifice deep enough to allow for a small amount of organic material, yet not so deep as to allow for correct faceting of the pavilion and crown on the unfinished gemstone

10. The method of claim 8, further comprising polishing the orifice using a mandrel and polishing paste prior to filling the orifice with organic material.

11. The method of claim 8, wherein the sealing material is non-allergenic.

12. The method of claim 8, further comprising allowing the sealing material to dry after affixing the sealing material to an opening of the orifice.

13. The method of claim 8, wherein the doping adhesive consists of at least one of a doping wax, two part epoxy, or cyanoacrylate.

14. The method of claim 8, further comprising mixing coloring materials with the organic material prior to inserting the organic material into the orifice of the gemstone.

15. A method of creating a gemstone filled with organic material comprising:
selecting a finished faceted gemstone,
mounting the faceted gemstone in a drilling fixture designed to hold the gemstone firmly in place during drilling,
drilling a orifice in a flat end of the faceted gemstone,
polishing the orifice using a mandrel and polishing paste,
inserting organic material into the orifice,
affixing a sealing material to the terminus end of the orifice, and
polishing the faceted gemstone.

16. The method of claim 15, wherein the finished faceted gemstone is a synthetically created crystal.

17. The method of claim 15, wherein the organic material inserted into the gemstone is the residual carbons of human ashes.

18. The method of claim 15, wherein the organic material inserted into the gemstone is the residual carbons of animal ashes.

19. The method of claim 15, wherein the organic material inserted into the gemstone consists of at least one of hair, DNA, or other organic material.

20. The method of claim 15, wherein the polishing paste is a fine diamond particulate paste.
